(19) United States
(12) Patent Application Publication
(10) Pub. No.: US 2003/0006207 A1
(43) Pub. Date: Jan. 9, 2003

(54) Single failure proof reeving load transfer system

(76) Inventor: Oddvar Norheim, Douglassville, PA (US)

Correspondence Address: KNOBLE & YOSHIDA, EIGHT PENN CENTER, SUITE 1350, 1628 JOHN F KENNEDY BLVD, PHILADELPHIA, PA, 19103, US

(21) Appl. No.: 10/171,338

(22) Filed: Jun. 14, 2002

Related U.S. Application Data
(60) Provisional application No. 60/298,249, filed on Jun. 14, 2001.

(51) Int. Cl. B66C 13/06

(52) U.S. Cl. 212/274

(57) ABSTRACT

A single failure proof hoisting apparatus includes a support frame, a load engaging member such as a support hook for supporting a workpiece, and first and second reeving systems mounted on the support frame for supporting the load engaging member. As is conventional in single failure proof systems, the first and second reeving systems are independent from each other so as to provide redundancy in the event of operational failure of one of the reeving systems. Most advantageously, the apparatus further includes a shock absorbing system for at least partially absorbing load transfer shock that will occur in a surviving one of the reeving systems when the other experiences operational failure. The shock absorbing system is designed to transmit a proportion of the load transfer shock to the support frame substantially within the horizontal plane, which facilitates absorption of the shock by the hoisting apparatus and minimizes instability that might otherwise be transmitted to the load engaging member. This provides a critical advantage when handling sensitive materials such as radioactive waste.

This application claims priority under 35 U.S.C. §119(e) based on U.S. Provisional Application S. No. 60/298,249, filed Jun. 14, 2001, the entire disclosure of which is hereby incorporated by reference as if set forth fully herein.

### BACKGROUND OF THE INVENTION

1. Field of the Invention

This invention relates to overhead hoists or crane systems and specifically to single failure proof systems of this type, which are used to transfer especially sensitive or critical loads such as nuclear waste.

2. Description of the Related Technology

A crane reeving system, i.e. the ropes that support the load engaging member or hook of an overhead hoist or crane, are made up of many falls, or parts of wire rope. In a standard crane design, two ropes are typically wound onto a wire rope drum. These ropes travel over pulleys or sheaves in the lower block of the system, which supports the load engaging member, and other pulleys and sheaves that are associated with the upper block of the system. An equalizer sheave that typically does not rotate is commonly provided at a location where the two ropes meet in order to equalize the line pull on all of the ropes, which dynamically changes during operation, especially as the load engaging member swings from side to side. Such a conventional reeving system could be made from one continuous length of wire rope and might use a sheave for an equalizer, or the reeving could be made from two separate pieces of rope and use a beam type equalizer.

In response to safety concerns arising out of the handling and transport of critical nuclear materials, regulations have been promulgated requiring a type of reeving that is described as single failure proof. In this reeving configuration, one of the two ropes can break and the system will continue to be operational. In a single failure proof system, each of the individual ropes is designed to safely support the entire lifted load in the event of breakage of the other rope. The problem to overcome during a broken rope event is the sudden, near instantaneous load transfer from the two intact reeving systems or ropes into the remaining rope. The design of the system must be such that the forces are limited during load transfer to prevent breakage of the second rope.

The most common single failure proof configuration incorporates a beam type equalizer in which each wire rope is terminated on a respective side of a beam. In operation, the beam functions like a large seesaw balancing the ropes. When breakage of one of the ropes occurs, large hydraulic or pneumatic cylinders absorbs the load transfer from the broken rope to the intact rope. Although such systems are functional, they tend to be quite heavy and expensive to construct and maintain. In addition, increased vertical stability of the load engaging member during breakage of one of the ropes during load conditions in such systems would be a worthwhile goal.

Another known configuration of a single failure proof system is described in U.S. Pat. No. 4,069,921 to Raugulis et al. This system includes an equalizer assembly that includes a shock absorbing system to dampen the effects of impact on the crane in the event that one of the ropes fails or a structural failure occurs. The shock absorbing system includes a pivot plate that is designed to rotate when one of the wire ropes experiences failure. Rotation of the pivot plate is resisted by a pair of shock absorbers. The mechanical aspect of this arrangement is that much of the transitional shock experienced during a wire rope failure is torsionally transmitted within a vertical plane to the support frame of the apparatus. Rotation of the pivot plate also has the effect of partially collapsing the support structure for the surviving wire rope by a significant magnitude. As a result of this, failure of one of the wire ropes when the apparatus is operating under load conditions may not result in a catastrophic failure of the entire apparatus, but it often will cause mechanical stress on the greater crane assembly as a result of the torsional force that is transmitted, as well as cause a significant downward vertical drop of the load engaging member and the workpiece. This is a significant concern, particularly in facilities that handle sensitive materials such as nuclear waste.

A need exists for an improved single failure proof hoisting system that is relatively inexpensive to construct and maintain, that minimizes the amount of drop that occurs when load is unexpectedly transferred to one of the wire ropes, and that ensures a smooth transfer of load under such conditions as compared to conventional systems of this type.

### SUMMARY OF THE INVENTION

Accordingly, it is an object of the invention to provide an improved single failure proof hoisting system that is relatively inexpensive to construct and maintain, that minimizes the amount of drop that occurs when load is unexpectedly transferred to one of the wire ropes, and that ensures a smooth transfer of load under such conditions as compared to conventional systems of this type.

In order to achieve the above and other objects of the invention, a single failure proof hoisting apparatus that is constructed according to a first aspect of the invention includes a support frame; a load engaging member; a first reeving system mounted on the support frame and supporting the load engaging member; a second reeving system mounted on the support frame and supporting the load engaging member, the second reeving system being independent of the first reeving system so as to provide a single failure proof redundancy in the event that one of the first and second reeving systems fails during operation; and shock absorbing structure for at least partially absorbing load transfer shock that will occur in a surviving one of the first and second reeving systems when the other of the first and second reeving systems fails during operation, the shock absorbing structure being constructed and arranged to transmit a proportion of the load transfer shock to the support frame substantially within the horizontal plane.

According to a second aspect of the invention, a single failure proof hoisting apparatus includes a support frame, a load engaging member, a first reeving system mounted on the support frame and supporting the load engaging member; a second reeving system mounted on the support frame and supporting the load engaging member, the second reeving system being independent of the first reeving system so as to provide a single failure proof redundancy in the event that one of the first and second reeving systems fails during operation, a shuttle carriage that is mounted for relative movement with respect to the support frame, a first equalizer assembly for compensating for operational variances within the first reeving system and a second equalizer assembly for compensating for operational variances within the second reeving system, and wherein the first and second equalizer assemblies are mounted on the shuttle carriage.

These and various other advantages and features of novelty that characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

FIG. 1 is a fragmentary side elevational view of a single failure proof hoisting apparatus that is constructed according to a preferred embodiment of the invention;

FIG. 2 is a fragmentary top plan view of the apparatus that is depicted in FIG. 1;

FIG. 3 is a diagrammatical view depicting a reeving configuration in the apparatus that is shown in FIGS. 1 and 2;

FIG. 4 is a second diagrammatical view depicting the reeving configuration that is shown in FIG. 3;

FIG. 5 is an isolational diagrammatical view depicting a shock absorbing system in the apparatus that is shown in FIGS. 1-4; and

FIG. 6 is a diagrammatical depiction illustrating force transmission characteristics in the shock absorbing system that is shown in FIG. 5.

### DETAILED DESCRIPTION OF THE PREFERRED EMBODIMENT(S)

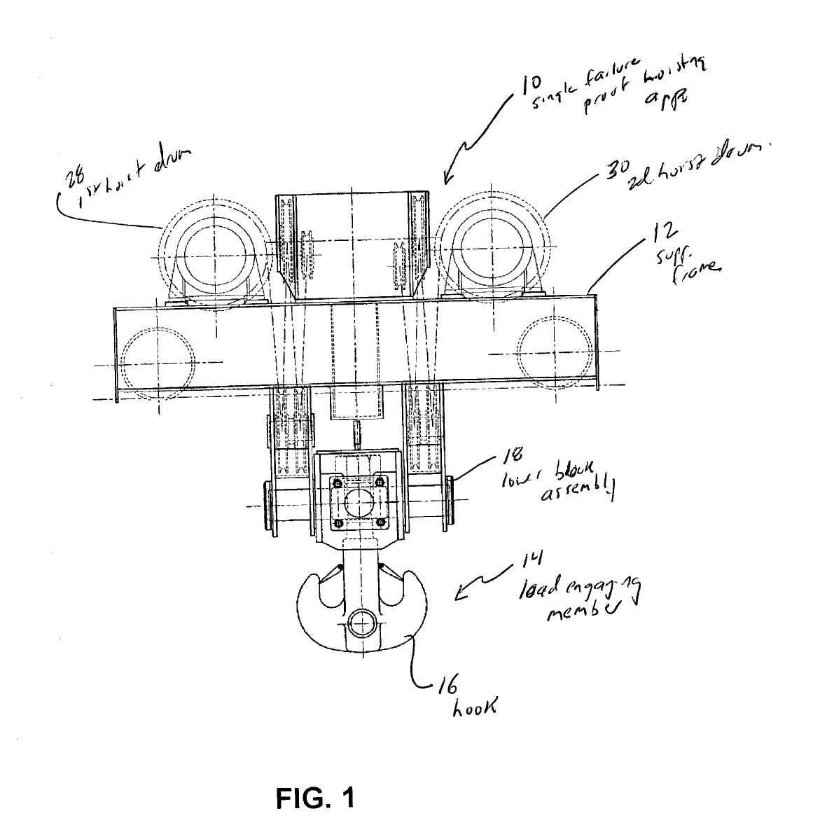

Referring now to the drawings, wherein like reference numerals designate corresponding structure throughout the views, and referring in particular to FIG. 1, a single failure proof hoisting apparatus 10 that is constructed according to the preferred embodiment of the invention includes a support frame 12 that, as is conventional, may be mounted on a traversing carriage within a large industrial facility in a building crane system. Hoisting apparatus 10 includes a load engaging member 14 that in the preferred embodiment is embodied as a lifting hook 16 for engaging a workpiece that is to be lifted or hoisted. Alternatively, load engaging member 14 may be embodied as any other structure that is capable of engaging a desired workpiece, such as a grab, an electromagnetic lifting device or other known alternatives.

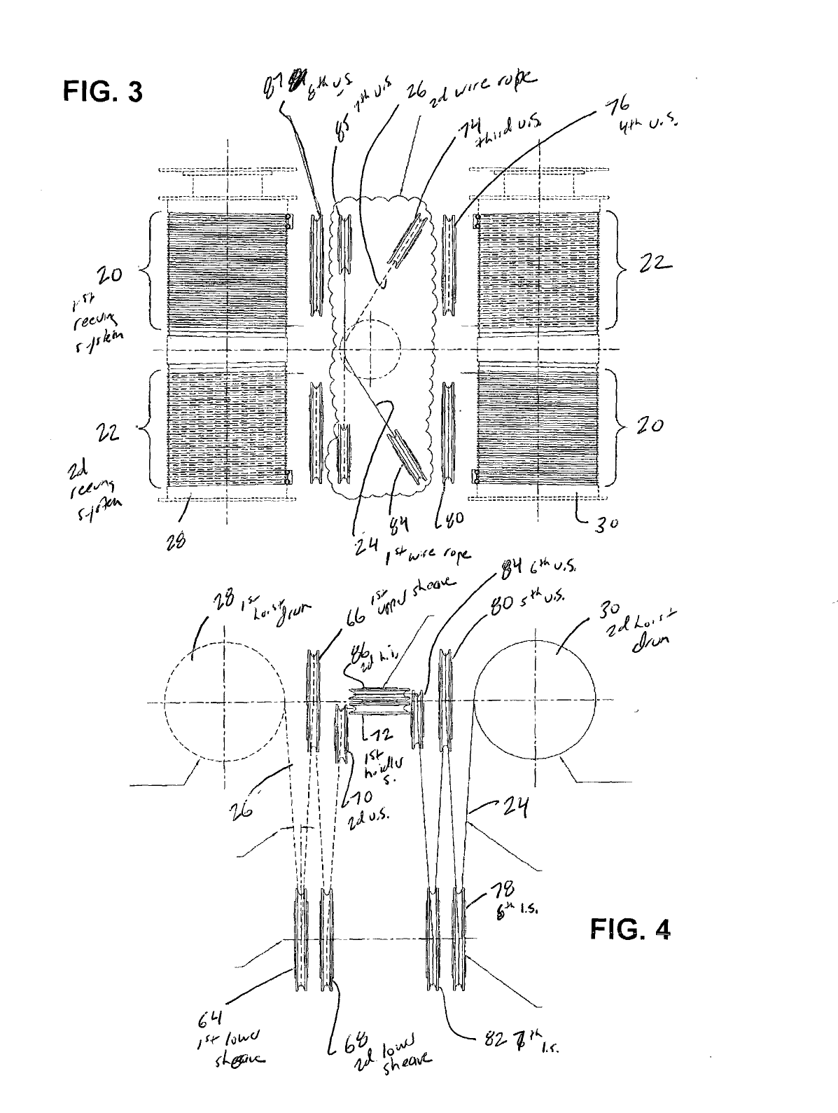

As may be seen in FIG. 1, load engaging member 14 is connected to a lower block assembly 18 that supports a plurality of sheaves for guiding a pair of wire ropes in an advantageous reeving arrangement that will be discussed in greater detail below. Looking briefly to FIG. 3, which is a diagrammatical depiction of the preferred reeving arrangement, it will be seen that the hoisting apparatus 10 preferably includes a first reeving system 20 that is mounted on the support frame 12 and that supports the lower block assembly 18 and the load engaging member 14 in suspension beneath the support frame 12. Similarly, a second reeving system 22 is mounted on the support frame 12 for independently supporting the lower block assembly 18 and the load engaging member 14. Accordingly, the presence of the first and second reeving systems 20, 22 provides a single failure proof redundancy in the event that one of the first and second reeving systems fails during operation.

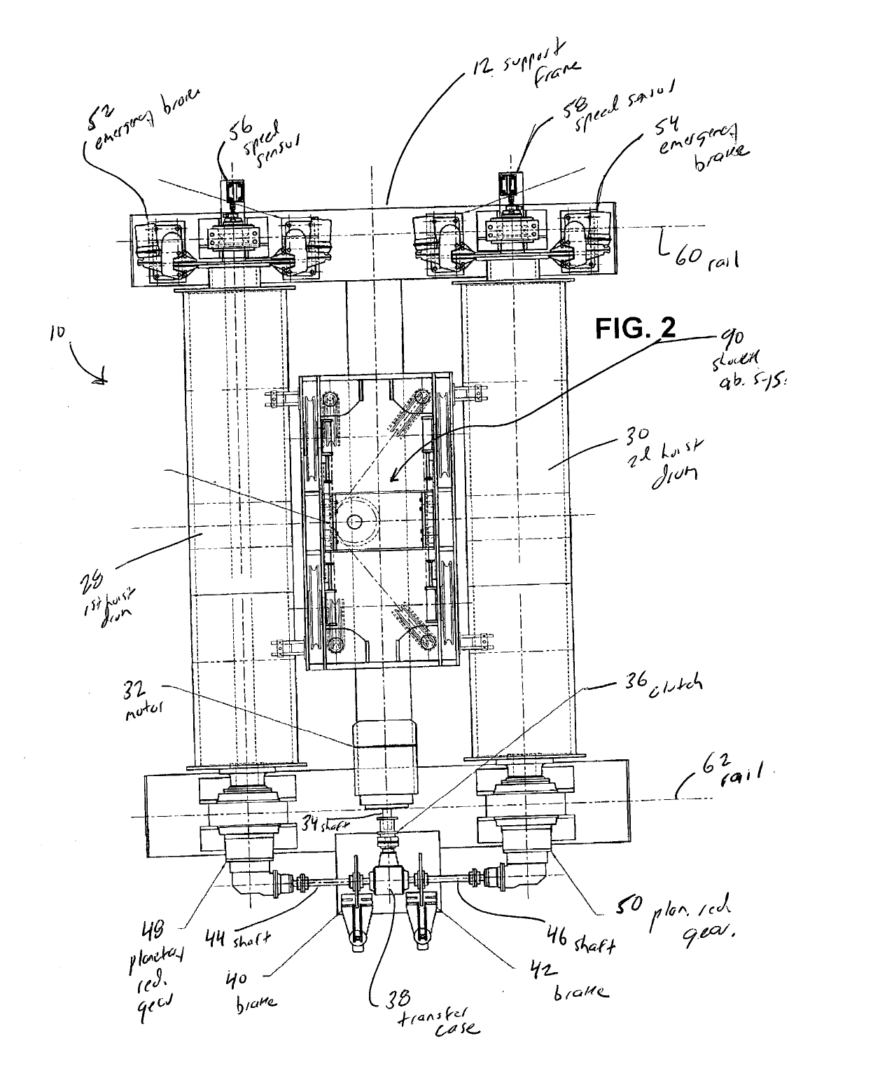

Looking again to FIG. 3, it will be seen that the first reeving system 20 includes a first wire rope 24 (which is depicted using a solid line in FIGS. 3 and 4) and that second reeving system 22 includes a second wire rope 26 (which is depicted as a broken line). Both the first and second reeving systems 20, 22 utilize a first hoist drum 28 that is positioned on a first side of the apparatus 10 as well as a second hoist drum 30 that is positioned on a second, opposite side of the apparatus 10. Referring now to FIG. 2, it will be seen that the apparatus 10 further includes a motor 32 for driving the first and second hoist drums 28, 30. Motor 32 includes a driveshaft 34 that is connected to an input shaft of a transfer case 38 via a clutch 36. Transfer case 38 drives a pair of output shafts 44, 46 that are respectively connected to a pair of reduction gear assemblies 48, 50. A pair of operational brakes 40, 42 are provided for braking the first and second hoist drums 28, 30 by applying a braking force to the shafts 44, 46. The gear assemblies 48, 50 are connected at their output ends to the central driveshafts, respectively, of the first and second hoist drums 28, 30. The opposite ends of the first and second hoist drums 28, 30 are operatively engaged with a pair of emergency brakes 52, 54 and a respective pair of speed sensors 56, 58.

As may be seen in FIG. 2, the entire apparatus 10 may be movable along a pair of rails 60, 62 that are shown schematically. Rails 60, 62 are part of a larger building crane system and ultimately the industrial facility itself.

According to one particularly advantageous feature of the invention, a shock absorbing system 90 is provided for at least partially absorbing load transfer shock that will occur in a surviving one of the first and second reeving systems 20, 22 when the other of the first and second reeving systems 20, 22 fails during operation. Preferably, the shock absorbing system 90 is constructed and arranged to counteract added strain that will tend to occur in the surviving reeving system as a result of the load transfer shock and the additional weight that will be shifted to the surviving reeving system as a result of the failure of the other reeving system. As a result, the amount of drop experienced by the load engaging member 14 in the event of an unexpected transfer of the entire load to one of the wire ropes is improved with respect to conventional systems. In addition, the accelerations that are experienced during such a load transfer are minimized, ensuring that the load transfer is as smooth as possible.

Looking again to FIGS. 3 and 4, it will be seen that both of the first and second reeving systems 20, 22 include a plurality of parts of wire rope that are guided about a plurality of upper and lower sheaves. Specifically, the second reeving system 22 is constructed so that the second wire rope 26 is unwound from first drum 28, traveling along a path downward to a first lower sheave 64, winding about the first lower sheave 64 and traversing an upward path to a first upper sheave 66, and then around the upper sheave 66 downwardly to a second lower sheave 68 which, like the first lower sheave 64, is located on the lower block assembly 18. The second wire rope 26 then extends around the second lower sheave 68 and upwardly to a second upper sheave 70, about which it travels for a quarter turn and extends into a second equalizer assembly that is embodied as a first horizontal idler sheave 72. The second wire rope 26 continues about the horizontal idler sheave 72 for a fraction of a turn and is then guided to a third upper sheave 74 which, as may be seen in FIG. 3, is oriented at an angle for purposes that will be discussed in greater detail below. Second wire rope 26 is guided about the third upper sheave 74 and then downwardly to a third lower sheave (not shown) and about the third lower sheave upwardly to a fourth upper sheave 76, which is visible in FIG. 3. It is then guided downwardly to a fourth lower sheave, about that sheave and then upwardly on to the second drum 30. Similarly, the first wire rope 24 of the first reeving system 20 is unwound from the second drum 30 downwardly to a fifth lower sheave 78 and then upwardly to a fifth upper sheave 80, downwardly to a sixth lower sheave 82 and then upwardly about a sixth upper sheave 84 and then to a first equalizer assembly that is embodied as a second horizontal idler sheave 86 that is mounted coaxially with the first horizontal idler sheave 72. The first wire rope 24 extends for a fraction of a turn about the second horizontal idler sheave 86 and is then guided about a seventh upper sheave 85 and then downwardly to a seventh lower sheave (not shown), upwardly to an eighth upper sheave 87, downwardly about an eighth lower sheave (not shown) and then upwardly on to the first hoist drum 28.

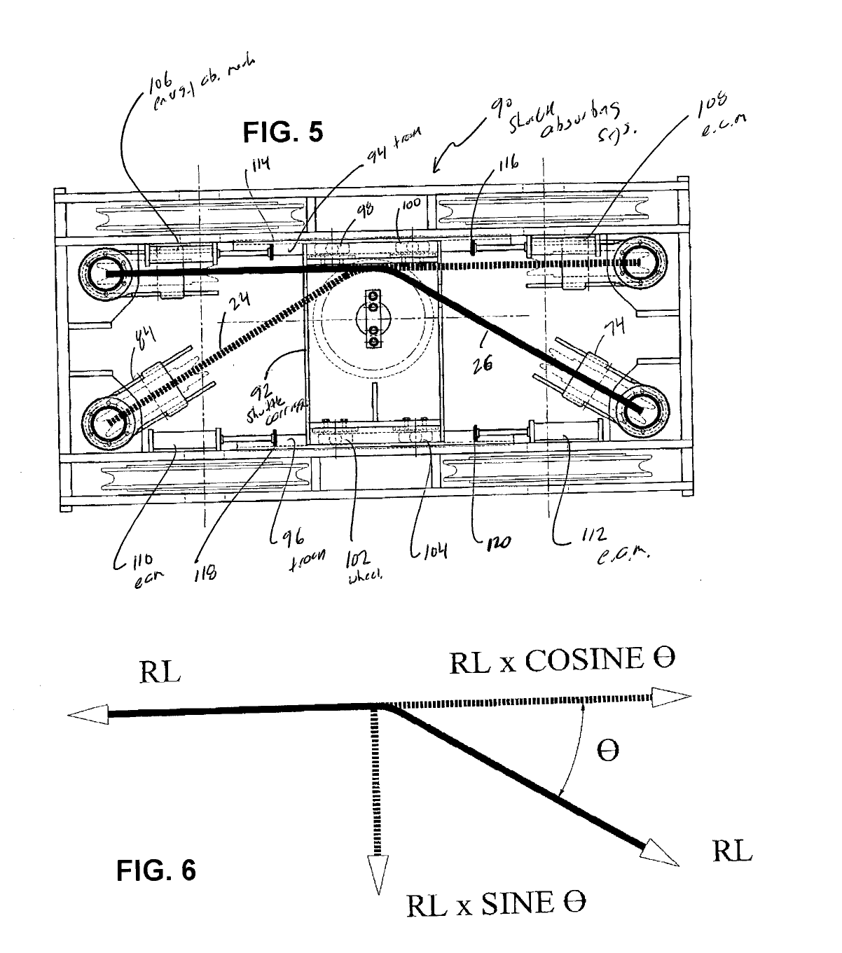

Referring now to FIG. 5, it will be seen that the shock absorbing system 90 preferably includes a shuttle carriage 92 on which both the first horizontal idler sheave 72 and the second horizontal idler sheave 86 are mounted. Shuttle carriage 92 is mounted for linear movement with respect to the support frame 12, and the support frame 12 is provided with a pair of guide tracks 94, 96 in which a plurality of wheels 98, 100, 102, 104 mounted to the shuttle carriage 92 are positioned to travel. A plurality of energy absorbing mechanisms 106, 108, 110, 112 are provided at predetermined locations with respect to the shuttle carriage 92 and the guide tracks 94, 96. As may be seen in FIG. 5, the energy absorbing mechanisms are arranged with respect to the shuttle carriage 92 so that the shuttle carriage 92 is permitted substantially free movement within a predetermined range of free motion in order to facilitate operation of the first and second equalizer assemblies during normal operation of the apparatus 10. The purpose of the energy absorbing mechanisms 106, 108, 110, 112, which are preferably constructed as hydraulic piston cylinder assemblies that have bumper elements 114, 116, 118, 120 at respective ends thereof, is to resist movement of the shuttle carriage 92 outside the predetermined range of free motion.

As may be seen in FIG. 5, tension within the first wire rope 24 of the first reeving system 20 will exert a force RL on the second horizontal idler sheave 86, and thus to the shuttle carriage 92, that is vectored at an angle θ with respect to the axis of movement of the shuttle carriage 92 with respect to the support frame 12. The angle θ is determined by the position of the sixth upper sheave 84 relative to the second horizontal idler sheave 86 and will also change depending upon the linear position of the shuttle carriage 92 during operation, but is preferably kept within the range, when the shuttle carriage 92 is in the neutral position, of about 26 degrees to about 36 degrees. More preferably, this angle is kept within a range of about 28 degrees to about 34 degrees, and most preferably, this angle is about 31 degrees. As is intuitively visible in FIG. 5, such tension within the first wire rope 24 and the resulting vector force RL will tend to urge the shuttle carriage 92 in the rightward direction, although much of the force will be applied laterally along an axis that is perpendicular to the path to travel of the shuttle carriage 92, thereby urging the shuttle carriage 92 against the support frame 12, and thereby transmitting much of the force into the support frame 12. As may be seen in FIG. 6, the amount of force that is applied along the component axis of travel of the shuttle carriage 92 may be determined by the formula RL times Cosine θ, while the amount of force that is being applied along the component axis that is perpendicular to the path of travel may be determined by the formula RL times Sine θ. Similarly, tension within the second wire rope 26 of the second reeving assembly 22 will exert a force on the first horizontal idler sheave 72 that is identical but symmetrically opposite to the vector force RL described above. The force that is exerted by the second wire rope 26 will tend to urge the shuttle carriage 92 in a leftward direction as viewed in FIG. 5.

During normal operation, the tension in the wire ropes 24, 26 of the respective reeving systems 20, 22 will be expected to be substantially identical, so the force components along the axis of travel of the shuttle carriage 92 will be expected to cancel each other out. In this state, any travel of the shuttle carriage 92 will be as a result of the normal operational forces, chiefly swaying of the lower block assembly 18 and the load engaging member 14. In the event that one of the wire ropes 24, 26 fails during operation, however, the entire force load created by the lower block assembly 18, the load engaging member 14 and the workpiece will be almost instantaneously shifted entirely to the surviving wire rope. If, for example, it is the second wire rope 26 that fails, a great deal of force will be instantaneously applied to the first wire rope 24, greatly increasing the magnitude of the vector force RL while at the same time negating the countervailing force that previously had been applied to the shuttle carriage 92 by the second wire rope 26. When this occurs, much of the increased force and the transitional shock will be transmitted to the support frame 12 because of the transmission angle θ discussed above. At the same time, the shuttle carriage 92 will be urged suddenly to the right and will contact the bumper elements 116, 120 so as to employ the energy absorbing mechanisms 108, 112 in order to absorb the residual amount of the force transfer shock that remains in the component direction of the path of travel of the shuttle carriage 92.

The shock absorbing system is thus designed to transmit a proportion of the load transfer shock to the support frame and this proportion is transmitted substantially within the horizontal plane. This facilitates absorption of the shock by the hoisting apparatus 10 and minimizes instability that might otherwise be transmitted to the load engaging member 14. In addition, less impact is transmitted into the bridge structure of the building. This provides a critical advantage when handling sensitive materials such as radioactive waste.

One important advantage that is provided by this embodiment of the invention is that by minimizing the relative accelerations that take place during the load transfer and as a result of the shifting of the carriage during the load transfer the amount of vertical drop that is experienced by the load engaging member will be minimized. The importance of this cannot be overstated when handling sensitive materials such as spent nuclear fuel.

Moreover, the positioning of the load transfer shock absorbing elements so as to travel substantially within the horizontal plane makes it possible to fabricate the system so as to have a relatively low vertical profile, making the system more suitable for retrofit applications.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. A single failure proof hoisting apparatus comprising:
a support frame;
a load engaging member;
a first reeving system mounted on said support frame and supporting said load engaging member;
a second reeving system mounted on said support frame and supporting said load engaging member, said second reeving system being independent of said first reeving system so as to provide a single failure proof redundancy in the event that one of said first and second reeving systems fails during operation; and
shock absorbing means for at least partially absorbing load transfer shock that will occur in a surviving one of said first and second reeving systems when the other of said first and second reeving systems fails during operation, said shock absorbing means being constructed and arranged to transmit a proportion of the load transfer shock to the support frame substantially within the horizontal plane.

2. An apparatus according to claim 1, further comprising a first equalizer assembly for compensating for operational variances within said first reeving system and a second equalizer assembly for compensating for operational variances within said second reeving system, and wherein said shock absorbing means comprises means for mounting said first equalizer assembly and said second equalizer assembly for movement with respect to said support frame.

3. An apparatus according to claim 2, wherein said means for mounting said first equalizer assembly and said second equalizer assembly for movement with respect to said support frame is constructed and arranged to permit movement of said first and second equalizer assemblies within a horizontal plane intersecting said support frame.

4. An apparatus according to claim 2, wherein said means for mounting said first equalizer assembly and said second equalizer assembly for movement with respect to said support frame comprises a shuttle carriage that is mounted for relative movement with respect to said support frame.

5. An apparatus according to claim 4, wherein said first equalizer assembly comprises a first horizontal idler sheave and said second equalizer assembly comprises a second horizontal idler sheave, and wherein said first and second horizontal idler sheaves are coaxially mounted on said shuttle carriage.

6. An apparatus according to claim 4, wherein said shuttle carriage is mounted for substantially free movement within a predetermined range of free motion in order to facilitate operation of said first and second equalizer assemblies during normal operation of the apparatus, and further comprising energy absorbing means for resisting movement of said shuttle carriage outside of said predetermined range of free motion.

7. An apparatus according to claim 4, wherein said shuttle carriage is mounted for substantially linear movement with respect to said support frame along a path of linear movement.

8. An apparatus according to claim 7, wherein said first equalizer assembly and said second equalizer assembly are positioned on said shuttle carriage and are oriented within said first and second reeving systems, respectively, so that forces transmitted to said first and second equalizer assemblies as a result of tension within said first and second reeving systems, respectively, will be transmitted to said shuttle carriage along an axis that is perpendicular to said path of linear movement to a greater extent than such forces will be transmitted to said shuttle carriage along an axis that is parallel to said path of linear movement, whereby a proportion of said forces will be transmitted to said support frame.

9. An apparatus according to claim 8, wherein said first equalizer assembly and said second equalizer assembly are positioned on said shuttle carriage and are oriented within said first and second reeving systems, respectively, so that a proportion of said forces are transmitted to said shuttle carriage along an axis that is perpendicular to said path of linear movement.

10. An apparatus according to claim 9, wherein said first equalizer assembly is positioned on said shuttle carriage and is oriented within said first reeving system so that forces transmitted to said first equalizer assembly as a result of tension within said first reeving system will bias said shuttle carriage in a first direction along said path of linear movement, and wherein said second equalizer assembly is positioned on said shuttle carriage and is oriented within said second reeving system so that forces transmitted to said second equalizer assembly as a result of tension within the second reeving system will bias said shuttle carriage in a second, opposite direction along said path of linear movement.

11. An apparatus according to claim 2, wherein said means for mounting said first equalizer assembly and said second equalizer assembly for movement with respect to said support frame is constructed and arranged to constrain said first and second equalizer assemblies for movement within a predetermined path, and wherein said first and second equalizer assemblies are oriented so that any additional forces imparted to one of said equalizer assemblies in the event of failure of one of said reeving systems will be transmitted primarily from said means for mounting said first equalizer assembly and said second equalizer assembly to said support frame in a direction that is nonparallel to said predetermined path of movement of said first and second equalizer assemblies.

12. A single failure proof hoisting apparatus comprising:
a support frame;
a load engaging member;
a first reeving system mounted on said support frame and supporting said load engaging member;
a second reeving system mounted on said support frame and supporting said load engaging member, said second reeving system being independent of said first reeving system so as to provide a single failure proof redundancy in the event that one of said first and second reeving systems fails during operation;
a shuttle carriage that is mounted for relative movement with respect to said support frame;
a first equalizer assembly for compensating for operational variances within said first reeving system; and
a second equalizer assembly for compensating for operational variances within said second reeving system; and wherein said first and second equalizer assemblies are mounted on said shuttle carriage.

13. An apparatus according to claim 12, wherein said first equalizer assembly comprises a first horizontal idler sheave and said second equalizer assembly comprises a second horizontal idler sheave, and wherein said first and second horizontal idler sheaves are coaxially mounted on said shuttle carriage.

14. An apparatus according to claim 12, wherein said shuttle carriage is mounted for substantially free movement within a predetermined range of free motion in order to facilitate operation of said first and second equalizer assemblies during normal operation of the apparatus, and further comprising energy absorbing means for resisting movement of said shuttle carriage outside of said predetermined range of free motion.

15. An apparatus according to claim 12, wherein said shuttle carriage is mounted for substantially linear movement with respect to said support frame along a path of linear movement.

16. An apparatus according to claim 14, wherein said first equalizer assembly and said second equalizer assembly are positioned on said shuttle carriage and are oriented within said first and second reeving systems, respectively, so that forces transmitted to said first and second equalizer assemblies as a result of tension within said first and second reeving systems, respectively, will be transmitted to said shuttle carriage along an axis that is perpendicular to said path of linear movement to a greater extent than such forces will be transmitted to said shuttle carriage along an axis that is parallel to said path of linear movement, whereby a proportion of said forces will be transmitted to said support frame.

16. An apparatus according to claim 15, wherein said first equalizer assembly and said second equalizer assembly are positioned on said shuttle carriage and are oriented within said first and second reeving systems, respectively, so that forces transmitted to said first and second equalizer assemblies as a result of tension within said first and second reeving systems, respectively, will be transmitted to said shuttle carriage along an axis that is perpendicular to said path of linear movement to a greater extent than such forces will be transmitted to said shuttle carriage along an axis that is parallel to said path of linear movement, whereby a proportion of said forces will be transmitted to said support frame.

17. An apparatus according to claim 15, wherein said first equalizer assembly and said second equalizer assembly are positioned on said shuttle carriage and are oriented within said first and second reeving systems, respectively, so that a proportion of said forces are transmitted to said shuttle carriage along an axis that is perpendicular to said path of linear movement.
